(19) United States
(12) Patent Application Publication
(10) Pub. No.: US 2026/0303571 A1
(43) Pub. Date: Oct. 1, 2026

(54) ENDPOINT DEVICE FOR VIRTUAL PRIVATE NETWORKS

(71) Applicant: Sophos Limited, Abingdon (GB)

(72) Inventors: David Geoffrey GEORGE, Kwazulu Natal (ZA); Christopher Adam TELFER, Port Matilda, PA (US)

(73) Assignee: Sophos Limited, Abingdon (GB)

(21) Appl. No.: 19/094,998

(22) Filed: Mar. 30, 2025

(51) Int. Cl. H04L 9/40

(52) U.S. Cl. CPC H04L 63/0272; H04L 63/0876; H04L 63/108; H04L 63/166

(57) ABSTRACT

A computer-implemented method includes receiving, at an endpoint device, a request to establish a virtual private network (VPN) from a client device. The method further includes authenticating, in user space at the endpoint device, the request from the client device. The method further includes performing, by a kernel space process at the endpoint device, operations including: identifying activity at a User Datagram Protocol (UDP) listener socket that is associated with the VPN, establishing a UDP tunnel between the endpoint device and the client device by mapping the UDP listener socket to a UDP connection between the endpoint device and the client device, receiving Transport Layer Security (TLS) packets from the client device over the UDP tunnel, performing TLS operations on the TLS packets independent of a user space application, and after performing the TLS operations, forwarding packet data directly into a kernel network stack.

### FIELD

Embodiments relate generally to transport layer security based virtual private networks. More particularly, embodiments relate to methods, systems, and computer-readable media that use a kernel space process on an endpoint device to establish a virtual private network.

### BACKGROUND

A Virtual Private Network (VPN) is a digital connection between a client device and a remote server operated by a VPN provider. VPNs may be used for secure communications, private browsing, work from home while accessing a work computer, etc.

Secure Socket Layer (SSL) is a security protocol that is used to create encrypted tunnels between the client device and the remote server. The encrypted tunnels are used to move data packets between devices. SSL VPNs may be implemented as user space software. As user space software, SSL VPN can require substantial computing power and memory resources, which can be wasteful and, in some cases (e.g., low-capacity devices), impose performance penalties on other user space processes (e.g. other applications running on the device).

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes receiving, at an endpoint device, a request to establish a virtual private network (VPN) from a client device. The method further includes authenticating, in user space at the endpoint device, the request from the client device. The method further includes performing, by a kernel space process at the endpoint device, operations including: identifying activity at a User Datagram Protocol (UDP) listener socket that is associated with the VPN, establishing a UDP tunnel between the endpoint device and the client device by mapping the UDP listener socket to a UDP connection between the endpoint device and the client device, receiving Transport Layer Security (TLS) packets from the client device over the UDP tunnel, performing TLS operations on the TLS packets independent of a user space application at the endpoint device, and after performing the TLS operations, forwarding packet data directly into a kernel network stack.

In some embodiments, the kernel space process performs additional operations including: receiving plain-text packets that are destined for the UDP tunnel and forwarding the plain-text packets to the kernel network stack. In some embodiments, the kernel space process performs additional operations including: receiving one or more incoming TLS records from a target server, decrypting the one or more incoming TLS records, and providing the one or more decrypted TLS records to the user space application. In some embodiments, the kernel space process performs additional operations comprising: receiving one or more outgoing TLS records from the user space application, encrypting the one or more outgoing TLS records, and transmitting the one or more encrypted outgoing TLS records to a target server.

In some embodiments, the method further includes implementing an offload path process for the TLS packets, where the offload path process is executed in a location selected from a group of the kernel space process, a network stack process, a Network Interface Card (NIC) of the endpoint device, a network processing unit of the endpoint device, or combinations thereof. In some embodiments, the method further includes responsive to establishing the UDP tunnel, tracking a time since establishment of the UDP tunnel, determining that a time threshold is reached based on tracking the time since establishment of the UDP tunnel, and in response to the time threshold being reached, renegotiating the UDP tunnel. In some embodiments, the method further includes maintaining a hash table that tracks active UDP connections per namespace, determining that the UDP connection is ended, and updating the hash table.

In some embodiments, the kernel space process performs additional operations including: implementing a link-local authentication mechanism for additional user space authentication in addition to TLS authentication based on the inner packets, where specific access control for link-local traffic is implemented before full traffic is allowed. In some embodiments, the method further includes authenticating the client device associated with the UDP tunnel by carrying authentication traffic over the UDP tunnel while blocking non-authentication traffic. In some embodiments, the method further includes establishing an interface between the user space and a kernel space of the endpoint device with one or more of a block device driver, a character device driver, a Netlink socket, shared memory, and combinations thereof. In some embodiments, the method further includes associating a respective identifier with the UDP connection and providing the respective identifier with the TLS packets that are forwarded from TLS processing directly into the kernel network stack.

An endpoint device includes one or more processors and one or more computer-readable media, coupled to the one or more processors and having instructions stored thereon that, when executed by the one or more processors, cause the one or more processors to perform operations. The operations include receiving a request to establish a virtual private network (VPN) from a client device; authenticating, in user space, the request from the client device; and identifying activity at a User Datagram Protocol (UDP) listener socket that is associated with the VPN, establishing a UDP tunnel between the endpoint device and the client device by mapping the UDP listener socket to a UDP connection between the endpoint device and the client device, receiving TLS packets from the client device over the UDP tunnel, performing TLS operations on the TLS packets independent of a user space application at the endpoint device, and after performing the TLS operations, forwarding packet data directly into a kernel network stack.

In some embodiments, the kernel space process performs additional operations including: receiving plain-text packets that are destined for the UDP tunnel and forwarding the plain-text packets to the kernel network stack. In some embodiments, the kernel space process performs additional operations including: receiving one or more incoming TLS records from a target server, decrypting the one or more incoming TLS records, and providing the one or more decrypted TLS records to the user space application. In some embodiments, the kernel space process performs additional operations comprising: receiving one or more outgoing TLS records from the user space application, encrypting the one or more outgoing TLS records, and transmitting the one or more encrypted outgoing TLS records to a target server.

A computer-program product that includes one or more non-transitory computer-readable media with instructions stored thereon that, when executed by an endpoint device, causes the endpoint device to perform operations. The operations include receiving a request to establish a virtual private network (VPN) from a client device; authenticating, in user space, the request from the client device; and identifying activity at a User Datagram Protocol (UDP) listener socket that is associated with the VPN, establishing a UDP tunnel between the endpoint device and the client device by mapping the UDP listener socket to a UDP connection between the endpoint device and the client device, receiving TLS packets from the client device over the UDP tunnel, performing TLS operations on the TLS packets independent of a user space application at the endpoint device, and after performing the TLS operations, forwarding packet data directly into a kernel network stack.

In some embodiments, the kernel space process performs additional operations including: receiving plain-text packets that are destined for the UDP tunnel and forwarding the plain-text packets to the kernel network stack. In some embodiments, the kernel space process performs additional operations including: receiving one or more incoming TLS records from a target server, decrypting the one or more incoming TLS records, and providing the one or more decrypted TLS records to the user space application. In some embodiments, the kernel space process performs additional operations comprising: receiving one or more outgoing TLS records from the user space application, encrypting the one or more outgoing TLS records, and transmitting the one or more encrypted outgoing TLS records to a target server.

### BRIEF DESCRIPTION OF THE DRAWINGS

FIG. 1 is a block diagram of a threat management system in a network environment, according to some embodiments described herein.

FIG. 2 is a block diagram of an example computing device, according to some embodiments described herein.

FIG. 3 is a block diagram illustrating an organization of a VPN gateway into user space, kernel space, and physical space, according to some embodiments described herein.

FIG. 4 is a block diagram that illustrates a user space and a kernel space that are part of an endpoint device, according to some embodiments described herein.

FIG. 5 is a block diagram that illustrates an example kernel module, according to some embodiments described herein.

FIG. 6 is an example flow diagram of a method to renegotiate a key, according to some embodiments described herein.

FIG. 7 is an example flow diagram of a method to monitor data acquisition and exfiltration, according to some embodiments described herein.

### DETAILED DESCRIPTION

### Overview

VPN establishes a digital connection between a client device and a remote server owned by a VPN provider. The remote server is an endpoint device that includes a security application that creates a point-to-point tunnel that encrypts data from the client device, masks an Internet Protocol (IP) address of the client device, and enables the client device to visit target servers (e.g., websites) without being tracked (since the client device network address is not transmitted to the target servers).

In some embodiments, a security application generates encrypted tunnels using a security protocol. One security protocol is Transport Layer Security (TLS). When TLS over Transmission Control Protocol (TCP) is used to create tunnels, the system may experience a “TCP meltdown” where the congestion control mechanisms of the inner and outer TCP connections experience conflicts and cause traffic to decrease or halt for extended periods of time even when congestion is minimal.

In some embodiments, Datagram TLS (DTLS) may be used, which is a security protocol similar to TLS, but provides security to datagram-based applications. DTLS may use User Datagram Protocol (UDP) to transmit packets. The advantage of using DTLS over UDP as an outer VPN transport avoids “TCP meltdown” because the inner TCP connection does not have an outer TCP connection to cause conflicts.

The security application may use user space memory and kernel space memory. User space is where application software may operate, such that application software has access to data stored in user space memory; kernel space is reserved for operating system processes, such that data stored in kernel space memory cannot be accessed by application software (user space processes). However, user space operations are inefficient and can be vulnerable to security threats.

The security application described herein uses a TLS VPN in the kernel space that has lower packet processing overhead than that associated with traditional user space network sockets and tunnel network devices. As a result, the security application uses less processing power and less memory while supporting secure VPN connections. In addition, performing processes in the kernel space results in processes that have greater security due to the privilege required to access data stored in kernel space memory.

In various embodiments, the security application at an endpoint device (e.g., implemented at a server) receives a request to establish a VPN from a client device that is remote from the server. A user space process (e.g., executing in and having access to user space memory, e.g., implemented by a user space virtual server at the endpoint device) authenticates the request from the client device. A kernel space process (e.g., performed by a module that executes in and has access to kernel space memory) identifies activity at a UDP listener socket that is associated with the VPN, establishes a UDP tunnel between the endpoint device and the client device by mapping the UDP listener socket to a UDP connection between the endpoint device and the client device, receives TLS packets from the client device over the UDP tunnel, performs TLS operations independent of the user space application, and forwards packet data directly into a kernel network stack.

### Network Environment

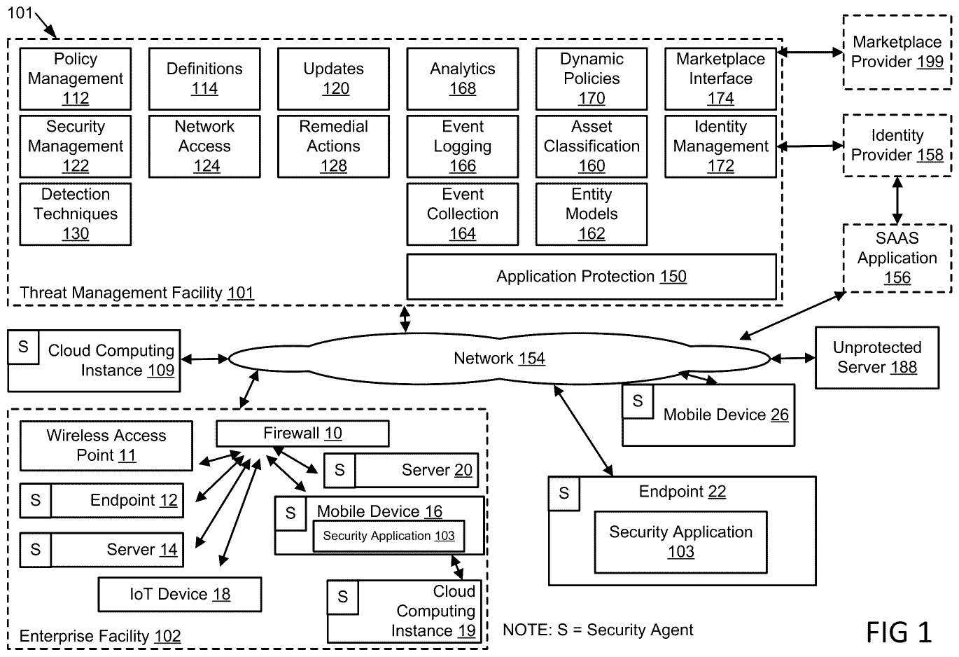

FIG. 1 depicts a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, an exemplary enterprise facility 102 may be or may include any networked computer-based infrastructure. For example, the enterprise facility 102 may be corporate, commercial, organizational, educational, governmental, or the like. As home networks get more complicated, and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is merely exemplary, and it will be understood that there may be any number of compute instances, less or more of each type of compute instances, and other types of compute instances. As shown, the exemplary enterprise facility includes a firewall 10, a wireless access point 11, an endpoint 12, a server 14, a mobile device 16, an appliance or IOT device 18, a cloud computing instance 19, and a server 20. Again, the compute instances 10-20 depicted are exemplary, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 172, and marketplace management facility 174, as well as other facilities. For example, there may be a testing facility, a threat research facility, and other facilities. It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In embodiments, the identity provider 158 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In some implementations, the endpoint 22 and/or the mobile device 26 include a security application 103 that is discussed in greater detail below. In some implementations, the security application 103 may be stored on other compute instances in the enterprise facility 102, such as endpoint 12, server 14, server 20, etc. In some implementations, the security application 103 may be stored on other components outside the enterprise facility 102, such as mobile device 26, cloud computing instance 109, etc.

In some implementations, compute instances 10-26 may communicate with cloud applications, such as a SaaS application 156. The SaaS application 156 may be an application that is used by but not operated by the enterprise facility 102. Exemplary commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server 188 such as a web site or a third-party application through an internetwork 154 such as the Internet or any other public network, private network, or combination of these.

In embodiments, aspects of the threat management facility 100 may be provided as a stand-alone solution. In other embodiments, aspects of the threat management facility 100 may be integrated into a third-party product. An application programming interface (e.g. a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to directly 100. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 150 provided by the cloud, and so on.

In an embodiment, the security management facility 122 may provide for email security and control, for example to target spam, viruses, spyware, and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Exemplary rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Exemplary policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for download and/or transmitting the information. In an embodiment, the policy management facility 112 and the security facility 122 may work in concert with the update management facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For examples, operating systems may provide process and usage information that accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An exemplary event may be communication of a specific packet over the network. Another exemplary event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

### Computing Device

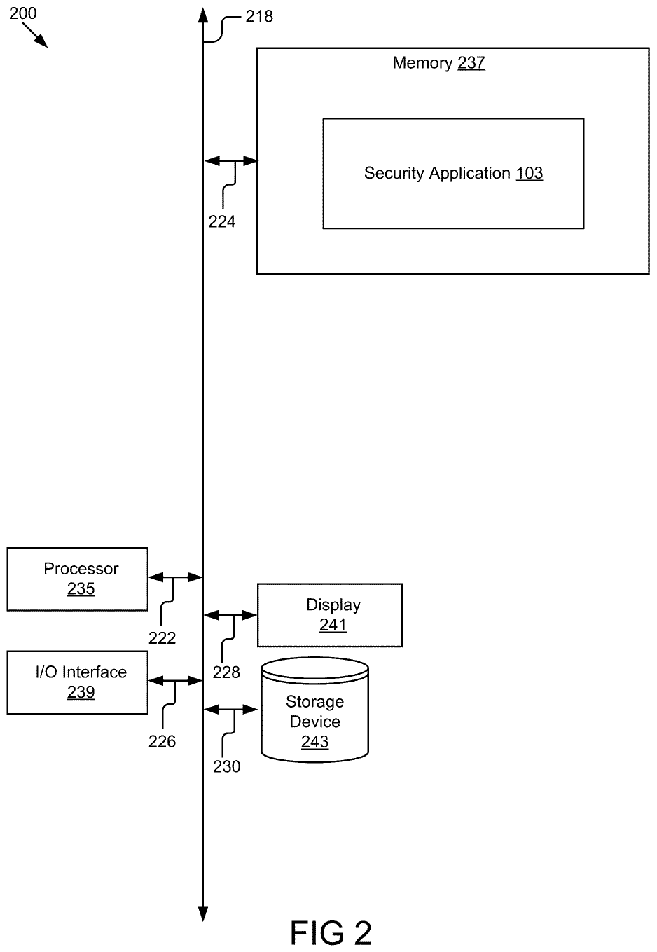

FIG. 2 is a block diagram of an example computing device 200 that may be used to implement one or more features described herein. Computing device 200 can be any suitable computer system, endpoint device, server, or other electronic or hardware device. In some embodiments, computing device 200 is endpoint 22 or mobile device 26 in FIG. 1.

In some embodiments, computing device 200 includes a processor 235, a memory 237, an input/output (I/O) interface 239, a display 241, and a storage device 243, all coupled via a bus 218.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200. The processor 235 is coupled to the bus 218 for communication with the other components via signal line 222.

The memory 237 may be a computer-readable media that stores instructions that may be executed by the processor 235 and/or data. The instructions may include code and/or routines for performing the techniques described herein. The memory 237 may be a dynamic random-access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the security application 103, which is described in greater detail below. During operation, memory 237 may be divided into user space memory (accessible to the device operating system and applications) and kernel space memory (accessible only to the device operating system and processes that have system privilege, e.g., security software). The memory 237 is coupled to the bus 218 for communication with the other components via signal line 224.

The I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 243), and input/output devices can communicate via the I/O interface 239. In another example, the I/O interface 239 can receive data, such as an input dataset, from an enterprise facility 102 and deliver the data to the security application 103 and components of the security application 103, such as the processing module 202. In some embodiments, the I/O interface 239 can connect to interface devices such as input devices (keyboard, pointing device, touchscreen, microphone, camera, scanner, sensors, etc.) and/or output devices (display devices, speaker devices, printers, monitors, etc.). The I/O interface 239 is coupled to the bus 218 for communication with the other components via signal line 226.

Some examples of interfaced devices that can connect to I/O interface 239 can include a display 241 that can be used to display content, e.g., an identification of a process that is associated with a security threat. The display 241 can include any suitable display device such as a liquid crystal display (LCD), light emitting diode (LED), or plasma display screen, cathode ray tube (CRT), television, monitor, touchscreen, three-dimensional display screen, or other visual display device. The display 241 may be coupled to the bus 218 via signal line 228.

The storage device 243 stores data related to the security application 103. For example, the storage device 243 may store data associated with the security application 103. The storage device 243 may be coupled to the bus 218 via signal line 230.

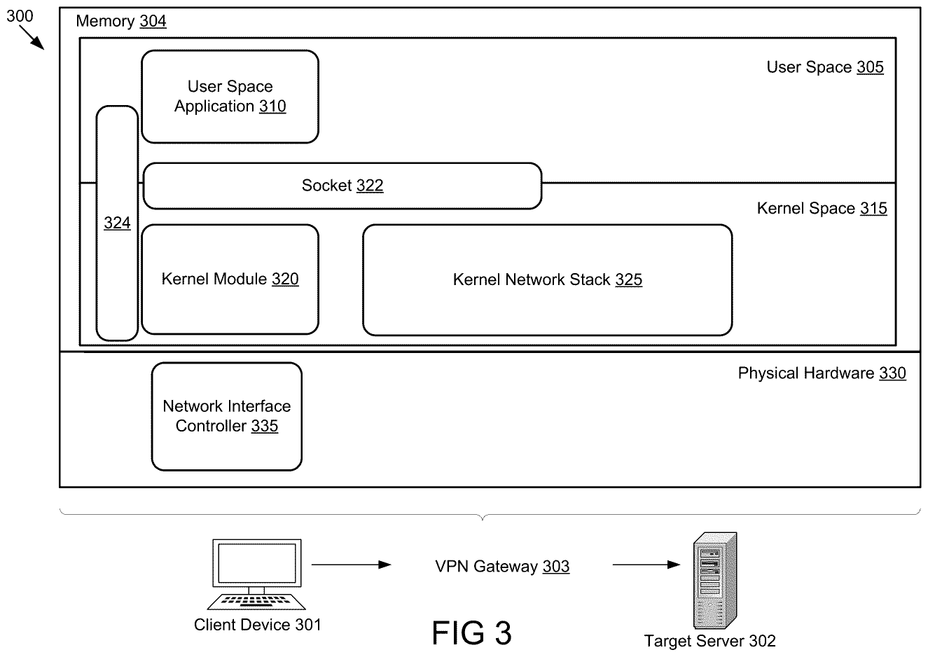

FIG. 2 illustrates a computing device 200 that executes an example security application 103 stored in the memory 237. While the security application 103 is illustrated as being stored in memory 237, as will be described in greater detail below with reference to FIG. 3, the memory 237 may be divided into a user space and a kernel space and the security application 103 may include a user space application with access only to user space memory (and no access to kernel space memory) and a kernel module with access to kernel space memory.

In some embodiments, the security application 103 receives, at an endpoint device, a request to establish a VPN from a client device. The security application 103 authenticates in user space the request from the client device. The security application 103 performs, by a kernel space process at the endpoint device, operations comprising: identifying activity at a UDP listener socket that is associated with the VPN, establishing a UDP tunnel between the endpoint device and the client device by mapping the UDP listener socket to a UDP connection between the endpoint device and the client device, receiving TLS packets from the client device over the UDP tunnel, performing TLS operations on the TLS packets independent of a user space application, and forwarding packet data directly into a kernel network stack.

### VPN Gateway

FIG. 3 is a block diagram 300 illustrating the organization of a VPN gateway 303 into memory 304 and physical hardware 330. The VPN gateway 303 receives and transmits data between a client device 301 and a target server 302. The client device 301 may be implemented as one or more endpoint devices illustrated in FIG. 1, such as endpoint 12 and/or endpoint 22. The client device 301 may also be implemented as mobile device 16, depending on whether the VPN gateway 303 is a virtual device (e.g., a virtual machine) that is stored on the mobile device 16 and/or the endpoint 22 (or other compute instances in enterprise facility 102) or whether the VPN gateway 303 is a separate hardware device. The VPN gateway 303 may be implemented as an instance within cloud computing instance 109 in FIG. 1. The target server 302 may be implemented as unprotected server 188 illustrated in FIG. 1.

The memory 304 is partitioned into user space 305 and kernel space 315. The VPN gateway 303 may be a virtual device (e.g., a virtual machine) that is stored on the client device 301 or a hardware device that is configured as an endpoint device. The VPN gateway plays the role of a bridge in a VPN topological structure by delivering packets to destinations, ranging from the client device 301 inside its virtual private network to one or more target servers 302 outside its virtual private network to enable user access to cloud resources.

The VPN gateway 303 processes packets from the client device 301 and packets from the target server 302. Packets may include TLS packets, which are transmitted using a TLS communication protocol. A TLS packet encapsulates an inner packet within an outer packet. The inner packet includes a data payload of an application of the client device 301. The inner packet is encrypted and encapsulated as the TLS payload of the outer packet. Packets may also include plain-text packets, which are not encrypted.

The VPN gateway 303 receives TLS packets through a Network Interface Controller (NIC) 335, which is physical hardware 330 in the VPN gateway 303. In a traditional VPN gateway, a NIC driver, which is an element of the kernel network stack 325, passes TLS packets to other components of the kernel network stack 325 in kernel space 315. In such a setup, the TLS packets are then transmitted to a user space application 310 in user space 305. The user space application 310 performs decryption and routes the TLS packets to the kernel network stack 325 to execute source Network Address Translation (NAT) and send the TLS packets to the target server 302.

Unlike a traditional VPN gateway, the security application 103 is a modified VPN gateway 303 that uses more kernel processes to reduce the computational cost of facilitating a VPN and to increase the security of the VPN. For example, the security application 103 implements tunnel packet handling in the kernel space 315 such that the TLS packets are not processed in user space 305.

User space application 310 executes in user space 305 such that user space application 310 has access to memory addresses allocated to user space 305, but not to any memory addresses in kernel space 315. The user space application 310 can include programs and libraries that the operating system uses to interact with the kernel. When a request for a VPN connection is received by the VPN gateway 303, the user space application 310 authenticates the request. In some embodiments, authentication includes a TLS handshake process where messages are exchanged between the client device 301 and an endpoint device to establish mutual trust.

The kernel space 315 refers to a memory partition that stores data that is only accessible to processes with operating system privilege The security application advantageously uses the kernel space 315 for perform VPN processes with lower processing overhead; however, more complicated processes are performed by user space processes. For example, the kernel processes may include exception handling, such as when an alert message is received and/or an error is detected. Another example may include the teardown processes that occur when the VPN connection to the client device closes.

The user space application 310 receives inter-process communications (IPCs) from processes executing in the kernel space 315 via an interface 324. The interface 324 is any mechanism that can be used to establish a communication channel, such as a block device driver, a character device driver, a Netlink socket, and/or shared memory.

Kernel space 315 is traditionally reserved for running a privileged operating system kernel, kernel extensions, and device drivers. In some embodiments, the security application 103 implements processes for the VPN using a kernel module 320 that identifies a listener socket 322, maintains UDP connections, performs TLS operations, and forwards packet data to the kernel network stack 325.

### User Space and Kernel Space with a Network Stack

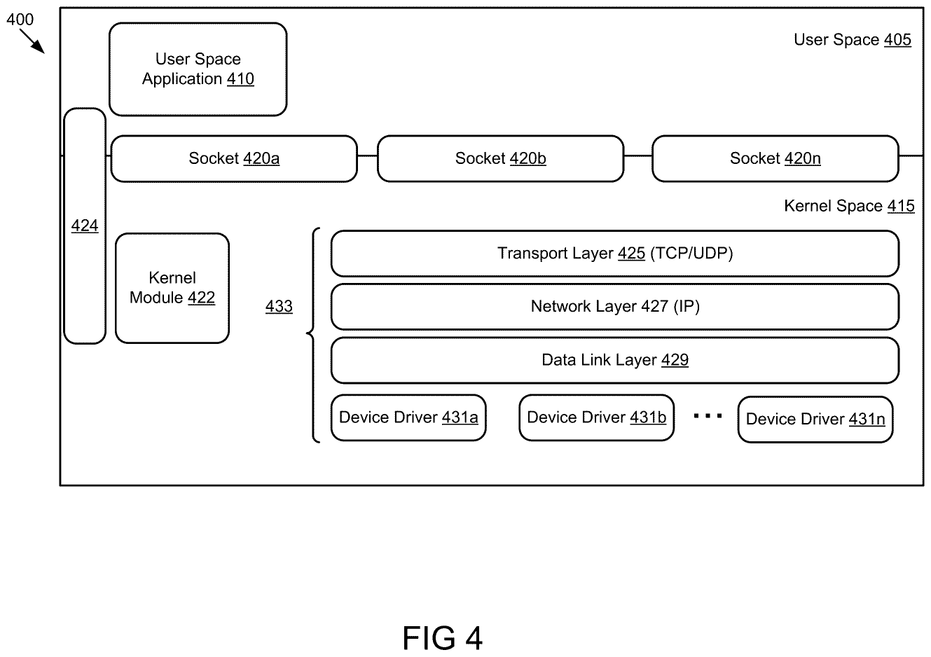

FIG. 4 is a block diagram that illustrates a user space 405 and a kernel space 415 in the memory of an endpoint device 400, according to some embodiments described herein. The user space 405 includes a user space application 410. The kernel space 415 includes a kernel module 422 and a kernel network stack 433. An interface 424 provides communications between the user space 405 and the kernel space 415.

The kernel network stack 433 is illustrated as having four different layers: a transport layer 425, a network layer 427, a data link layer 429, and device drivers 431. The transport layer 425 is responsible for transmitting data to the user space application 410 based on protocols including Transmission Control Protocol (TCP) and UDP. The network layer 427 implements the Internet Protocol (IP) for relaying datagrams across network boundaries. The data link layer 429 is responsible for node-to-node delivery of dat. The device drivers 431 enable communication between an operating system or application of endpoint device 400 and hardware or peripheral devices. The sockets 420 may also be considered a kernel network stack 433 layer. Other layers may be present and other transmission protocols may be used for different endpoint device functions.

The endpoint device 400 handles packets received from a client device for transmission to a target server, the reverse process of packets received from the target server for the client device, and communications between different client devices that are on the same private network. Packets arrive at a device driver 431, e.g., via hardware network interface. In some embodiments, the data link layer 429 transfers the packets between network entities. For example, the data link layer 429 may transfer the packets from the device driver 431 to a socket 420 for use by a user space application 410 that executes on a processor of endpoint device 400.

The transport layer 425 implements different transmission protocols with different functionalities. For example, TCP is a message delivery service that uses a retransmission and acknowledgement scheme. TCP may be used for file transfers where it is important to have packet retention and packets that arrive in the correct order. TCP is used for the Transport Layer Security (TLS) protocol.

Another protocol is Datagram Transport Layer Security (DTLS), which is used for transmitting datagrams. A datagram encapsulates a data packets with information that may be used to route the data packets to a target server without a prior connection between a client device and the target server. Instead of using TCP for transmitting packets, DTLS is built on top of UDP. A UDP layer retains no state of UDP messages once sent, but when used as part of DTLS the data packets are not lost or reordered.

In some embodiments, the endpoint device 400 receives a request to establish a VPN from a client device. The user space application 410 authenticates the request from the client device in user space. For example, the user space application 410 handles TLS control, such as TLS handshakes. In some embodiments, the user space application 410 performs the following additional steps: retrieves certificates and keys associated with a target server, verifies client certificate fingerprints, configures tunnel authentication configuration, and performs tunnel tear-down.

The kernel module 422 performs kernel space processes including identifying activity at a socket 420 (e.g., a UDP listener socket) that is associated with the VPN. Once the socket 420 identifies activity, the user space application 410 establishes a UDP tunnel between the endpoint device 400 and the client device by mapping the socket 420 (e.g., the UDP listener socket) to a UDP connection between the endpoint device and the client device. One UDP listener socket may map to multiple UDP connections with one UDP connection per unique source port and IP address. In some embodiments, different sockets may be associated with different VPN connections for different client devices. In some embodiments, the UDP tunnel is not used until a specific, secure negotiation takes place over the UDP tunnel. This advantageously avoids modifying the industry standard TLS protocol while preserving security; allows the mechanisms to be flexibly extended; and keeps traffic on the same UDP connection, which improves the processes for interacting with load balancers and firewalls.

The kernel module 422 receives TLS packets from the client device over the UDP tunnel. The kernel module 422 performs TLS operations on the TLS packets independent of the user space application 410. For example, the kernel module 422 performs TLS record operations on the TLS packets including decrypting the TLS packets to obtain packet data, reading packet data for transmission, fragmenting messages into manageable chunks of data, compressing the packet data if compression is required and enabled, and calculating a Medium Access Control (MAC) address that is assigned to the NIC for use as a networking address. Once the TLS operations are completed, the kernel module 422 forwards the packet data directly into the kernel network stack 433 using a virtual network device that is mapped to the UDP tunnel. The packet data may be transmitted to a target server.

In some embodiments, the kernel module 422 receives plain-text packets from a server that are destined for the UDP tunnel. The kernel module 422 performs TLS operations independent of the user space application 410. For example, the kernel module 422 verifies a MAC address associated with the packet data, decompresses the packet data if compression is required and enabled, and reassembles message fragments in the packet data. Decryption is not included because plain-text packets do not require decryption. Once the TLS operations are completed, the kernel module 422 encapsulates the packet data into a DTLS tunnel packet and forwards the packet data directly into the kernel network stack 433 to transmit the packet data back to the client.

In some embodiments, the kernel module 422 receives incoming TLS records from a target server or other client device. A TLS record is a type of TLS packet that contains information to manage the TLS connection. A security application uses the TLS control record for functions including an initial protocol handshake, connection termination, alerts for abnormal conditions, and key renegotiation. The kernel module 422 decrypts the incoming TLS records and transmits the decrypted TLS records to the user space application 410 using the interface 424. In some embodiments, the kernel module 422 receives unencrypted outgoing TLS records from the user space application 410 via the interface 424, encrypts the outgoing TLS records, and transmits the encrypted outgoing TLS records to a target server or other client device.

In some embodiments, the kernel module 422 implements an offload path process for the TLS packets. Offloading improves efficiency and performance of the VPN by offloading the TLS decryption to a separate location. The offload path process may be executed in a separate location selected from a kernel space process, a network stack process, a NIC of the endpoint device 400, and/or a network processing unit of the endpoint device 400.

The interface 424 manages any process that can be used to establish a communication channel between the kernel module 422 and the user space application 410. The interface 424 may include a block device driver, a character device driver, a Netlink socket, and/or shared memory. The interface 424 facilitates communication between the kernel space 415 and the user space 405 for networking-related tasks, such as forwarding of tunnel traffic, configuring network interfaces, monitoring network events, and exchanging data packets.

### Kernel Module

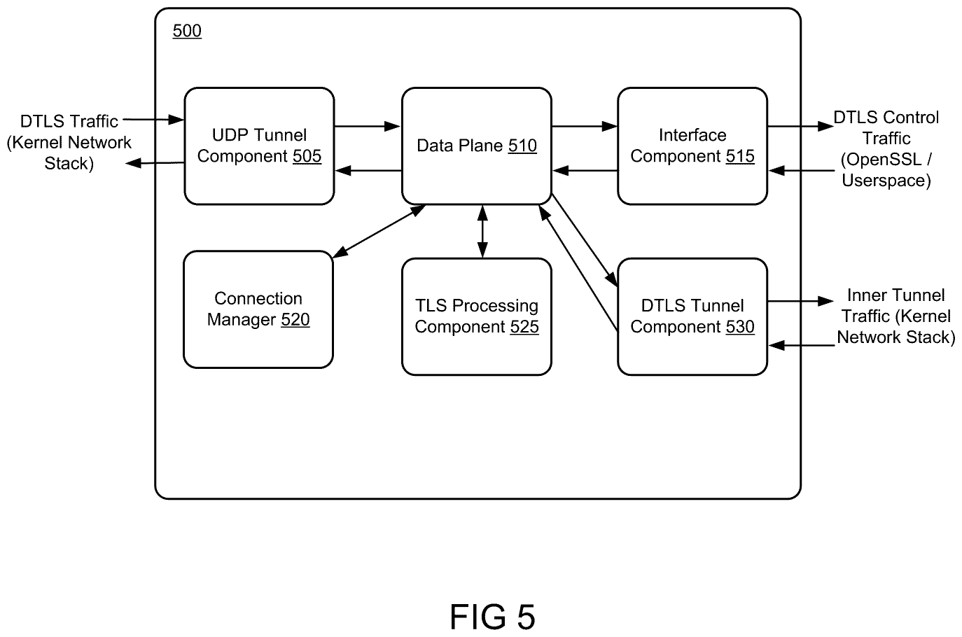

FIG. 5 is a block diagram that illustrates an example kernel module 500, according to some embodiments described herein. The kernel module 500 includes a UDP tunnel component 505, a data plane 510, an interface component 515, a connection manager 520, a TLS processing component 525, and a DTLS tunnel component 530.

The UDP tunnel component 505 creates the UDP tunnel. In some embodiments, the UDP tunnel component 505 creates the UDP tunnel by sending a message to a client register that includes a unique connection identifier and a client Universally Unique Identifier (UUID) from a certificate. The UDP tunnel component 505 receives a client register response that includes the unique connection identifier and local link parameters. The UDP tunnel component 505 sends a UDP tunnel creation instruction that includes the unique connection identifier and tunnel development. The UDP tunnel component 505 receives a forward enablement message that includes the unique connection identifier and tunnel source and destination IP addresses.

The UDP tunnel component receives DTLS traffic to and from from the UDP tunnel via the kernel network stack. The UDP tunnel component 505 tracks a time since the establishment of the UDP tunnel. If enough time elapses since the establishment of the UDP tunnel such that a time threshold is reached, the UDP tunnel component 505 renegotiates the UDP tunnel and resets the time.

The UDP tunnel component 505 exchanges information with the data plane 510. The data plane 510 carries traffic. For example, the data plane 510 may identify a destination address associated with packets and retrieve information needed to determine a path from a receiving element to an outgoing interface. The data plane 510 communicates with the UDP tunnel component 505, the interface component 515, the connection manager 520, the TLS processing component 525, and the DTLS tunnel component 530.

The interface component 515 handles transmission of data between the kernel module 500 and the user space application. In some embodiments, the interface component 515 is used for communication between the user space application and the kernel module 500 to set up UDP listening sockets in the kernel, to enable the user space application to assign UDP connections to Netlink connection sockets, transferring raw DTLS traffic to the user space application over per-connection sockets, transferring decrypted DTLS traffic to the user space application over per-connection sockets, transferring raw DTLS traffic from the user space application to the kernel module 500 to be transmitted through in-kernel UDP sockets, transferring offloaded DTLS traffic from the user space application to be transmitted through in-kernel UDP, configuring TLS keys to be used by in-kernel cryptography (packet encryption/decryption operations), and/or authentication controls as directed by a DTLS tunnel control server.

In some embodiments, the interface component 515 transmits instructions from the user space application to the kernel module 500 to: open a UDP socket in the kernel space, close a UDP socket in the kernel space, open a UDP listener socket, create a UDP connection socket based on listener socket activity, close a UDP listener socket, receive TLS data over a connection where the data may be offloaded, send TLS data over a connection where the data may be offloaded, set TLS keys for a connection, link a connection to a DTLS tunnel device, unlink a connection from a DTLS tunnel device, set a link-local address filter for connection, set forwarding address translation, and enable full traffic forwarding.

The connection manager 520 tracks a state of connections between a UDP listening socket and different UPD connections. For example, the connection manager 520 records the source port and IP address for each UDP connection. In some embodiments, the connection manager 520 associates a respective identifier with the UDP connection.

The connection manager 520 maintains a hash table that maps UDP 5-tuples to TLS state information as well as a virtual network interface in the container network namespace at which the TLS tunnel terminates (i.e., TLS packets coming from the tunnel come into the system through the network interface and packets sent to the network interface are encapsulated and sent through the TLS tunnel). The connection manager 520 tracks active UDP connections per namespace and determines the states of corresponding UDP connections based on the hash table. In some embodiments, the key for the hash table includes a source IP address and a destination IP address, a source port and a destination port, and a socket identifier. Connection identifiers may be allocated from a fixed size pool, where a size of the pool is configured at module insert time. The connection identifiers may have a cool-off period before reuse. The connection manager 520 may pin a connection to host connection handles and may free the connection when the host frees a connection or if a connection fails to be associated with a host connection.

The TLS processing component 525 performs processing of TLS packets. For example, the TLS processing component 525 may perform fragmentation of messages, compression of data, determination of integrity, authentication, and encryption. Determination of integrity includes a verification of the validity of provided identification material, such as verification of MAC addresses. The TLS processing component 525 may also calculate MAC addresses for outgoing TLS packets. In some embodiments, after the TLS processing component 525 completes processing the TLS packets, the TLS processing component 525 provides a respective identifier of the UDP connection with the TLS packets that are forwarded to the kernel network stack.

The DTLS tunnel component 530 manages inner tunnel traffic to and from the kernel network stack. The DTLS tunnel component 530 may use NetDev, which is a data structure in the kernel space that represents a physical or virtual network interface.

In some embodiments, the DTLS tunnel component 530 implements a link-local filter to allow a specific set of link-local addresses described in inner packets to be forwarded across the tunnel. The DTLS tunnel component 530 implements a link-local authentication mechanism for additional user space authentication in addition to the TLS authentication performed by the user space application and matches and translates a tunnel IP address directly supporting overlapping remote private addresses. A user may be authenticated through an identity provider or through finding an identity that a client device operating system authenticated when the user logged on. In some embodiments, the user may authenticate directly with a security application by presenting credentials (e.g., username and password, cryptographic token, etc.). Other authentication protocols may be used as well.

The specific access control for link-local traffic may be implemented before full traffic is allowed. In some embodiments, the client device associated with the UDP tunnel is authenticated by carrying authentication traffic over the UDP tunnel while non-authentication traffic is blocked. The authentication traffic may be carried using Ipv6 link-local communications using a source/destination pair allow list.

In some embodiments, the DTLS tunnel component 530 implements a forward enable filter that matches a configured report source IP address in the receiving direction and a configured local source IP address in the transmission direction. If the IP addresses do not match, no forwarding is performed. If the IP addresses match, the values are translated within a kernel driver to configured values.

The DTLS tunnel component 530 may perform incremental checksum fixups as part of the translation. DTLS VPN clients may share a common, virtual IP address. To avoid conflicts, the DTLS tunnel component 530 may perform Network Address Translation (NAT) to change addresses as packets traverse the tunnel interface. Changing the address parts of the headers makes the checksum portion of the packet incorrect. Rather than recalculate the checksum by summing all the bytes of the packet (i.e., the way a checksum is defined), the DTLS tunnel component 530 adjusts values of the provided checksums to account for which bytes changed in which headers.

### Methods

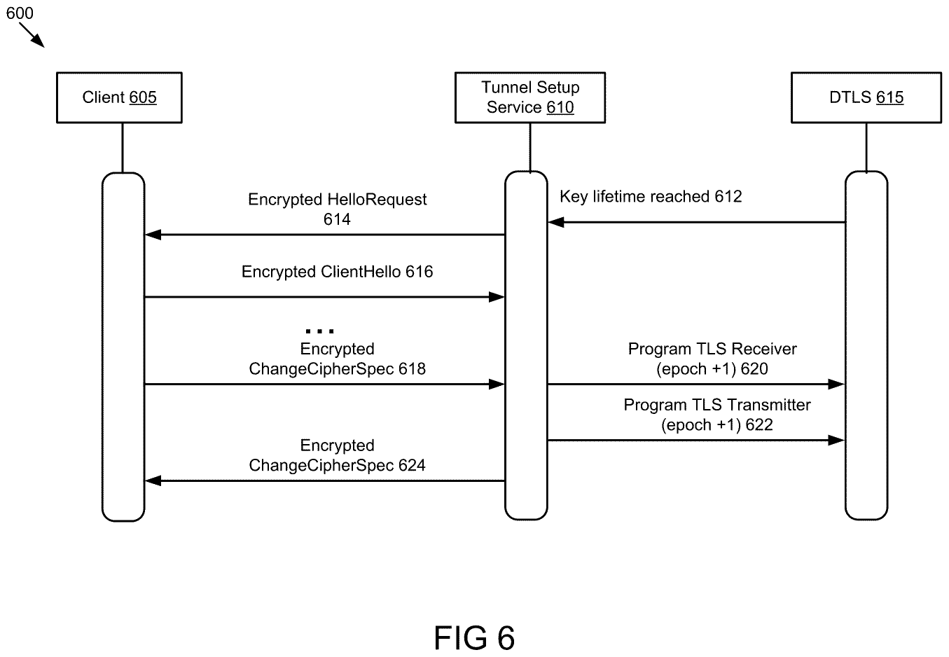

FIG. 6 is an example flow diagram of a method 600 to update keys for active sessions through renegotiation, according to some embodiments described herein. The method 600 includes a client 605, a tunnel setup service 610, and a DTLS 615. The tunnel setup service 610 maintains multiple key epochs through the TLS record layer. When a renegotiation is performed, the full TLS handshake is performed and new session keys are negotiated. The new keys are then used in a new epoch. Under conditions of reorder and packet loss, it is possible that both new and old epochs may be used concurrently.

In some embodiments, a given UDP tunnel connection is associated with configurable soft and hard time thresholds. A kernel module tracks a time since establishment of the UDP tunnel. Once a soft time threshold is met and a key lifetime is reached 612, the tunnel setup service 610 initiates a SSL renegotiation function call, which triggers sending an encrypted HelloRequest 614 to the client 605. The HelloRequest 614 starts a fresh handshake. The client 605 responds with an encrypted ClientHello 616. Other steps may occur. After completion of the handshake, the client 605 sends an encrypted ChangeCipherSpec 618 to the tunnel setup service 610, which updates the epoch and resets the timer. If the tunnel has not renegotiated after the hard threshold (not shown), the tunnel is torn down by the user space application. The tunnel setup service 610 transmits a program TLS receiver (epoch+1) 620 and a program TLS transmitter (epoch +1) 622 to the DTLS 615. The tunnel setup service 610 also transmits an encrypted ChangeCipherSpec 624 to the client 605.

The kernel module 422 may maintain two slots for TLS configurations: current and previous. The previous entry may be released a predetermined number of seconds (e.g., 60 seconds) after the current entry is programmed. In situations where the kernel module 422 handles receiver and transmitter offload, the TLS configuration is selected by the record epoch as read from the TLS record. In some embodiments, transmitter offload results in race conditions between tunnel traffic on the new epoch and control traffic, which sets up the epoch on the client side. The race conditions may be compounded by packet loss of control traffic, which would make it possible for multi-second periods between the transmission keys being programmed by the kernel module and associated receiver keys on the client 605. To avoid race conditions, the TLS configuration for transmission may be a very short amount of time (e.g., 1-2 seconds, 5 seconds).

In some embodiments where TLS offload in the kernel is occurring, the multi-epoch may impose new constraints because TLS renegotiation is forbidden. This may result in control traffic using the same session keys as offloaded traffic, which presents an issue with sharing sequence numbers. In some embodiments, a remote sequence number claim function is used that is triggered from user space/OpenSSL. In some embodiments, all traffic including control traffic is offloaded. In some embodiments, control traffic to OpenSSL and application traffic is transmitted to the kernel module so that each component manages replay protection for those sources.

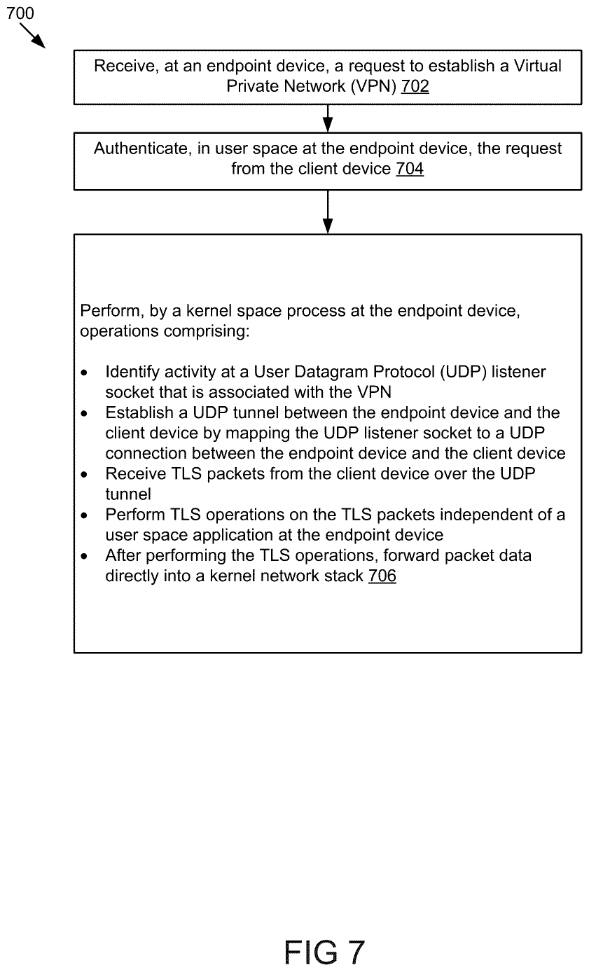

FIG. 7 is an example flow diagram of a method to monitor data acquisition and exfiltration, according to some embodiments described herein. The method 700 is performed by a computing device 200 of FIG. 2 or the user space application 310 and the kernel module 320 in FIG. 3. In some embodiments, the method 700 may be performed by the endpoint device 22 and/or a mobile device 26 in FIG. 1, or other user device coupled to a network.

The method 700 may begin at block 702. At block 702, an endpoint device receives a request to establish a VPN. Block 702 may be followed by block 704.

At block 704, user space at the endpoint device authenticates the request from the client device. Block 704 may be followed by block 706.

At block 706, a kernel space process at the endpoint device performs operations including: identifying activity at a User Datagram Protocol (UDP) listener socket that is associated with the VPN, establishing a UDP tunnel between the endpoint device and the client device by mapping the UDP listener socket to a UDP connection between the endpoint device and the client device, receiving TLS packets from the client device over the UDP tunnel, performing TLS operations on the TLS packets independent of a user space application at the endpoint device, and after performing the TLS operations, forwarding packet data of the TLS packets directly into a kernel network stack of the endpoint device.

In some embodiments, the kernel space process performs additional operations including: receiving plain-text packets that are destined for the UDP tunnel and forwarding the plain-text packets to the kernel network stack. In some embodiments, the kernel space process performs additional operations including: receiving one or more incoming TLS records from a target server, decrypting the one or more incoming TLS records, and providing the one or more decrypted TLS records to the user space application. In some embodiments, the kernel space process performs additional operations comprising: receiving one or more outgoing TLS records from the user space application, encrypting the one or more outgoing TLS records, and transmitting the one or more encrypted outgoing TLS records to a target server.

In some embodiments, the method further includes implementing an offload path process for the TLS packets, where the offload path process is executed in a location selected from a group of the kernel space process, a network stack process, a Network Interface Card (NIC) of the endpoint device, a network processing unit of the endpoint device, or combinations thereof. In some embodiments, the method further includes responsive to establishing the UDP tunnel, tracking a time since establishment of the UDP tunnel, determining that a time threshold is reached based on tracking the time since establishment of the UDP tunnel, and in response to the time threshold being reached, renegotiating the UDP tunnel. In some embodiments, the method further includes maintaining a hash table that tracks active UDP connections per namespace, determining that the UDP connection is ended, and updating the hash table.

In some embodiments, the kernel space process performs additional operations including: implementing a link-local authentication mechanism for additional user space authentication in addition to TLS authentication, wherein specific access control for link-local traffic is implemented before full traffic is allowed. In some embodiments, the method further includes authenticating the client device associated with the UDP tunnel by carrying authentication traffic over the UDP tunnel while blocking non-authentication traffic. In some embodiments, the method further includes establishing an interface between the user space and a kernel space with one or more of a block device driver, a character device driver, a Netlink socket, shared memory, and combinations thereof. In some embodiments, the method further includes associating a respective identifier with the UDP connection and providing the respective identifier with the TLS packets that are forwarded from TLS processing directly into the kernel network stack.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving, at an endpoint device, a request to establish a virtual private network (VPN) from a client device;
authenticating, in user space at the endpoint device, the request from the client device; and
performing, by a kernel space process at the endpoint device, operations comprising:
identifying activity at a User Datagram Protocol (UDP) listener socket that is associated with the VPN;
establishing a UDP tunnel between the endpoint device and the client device by mapping the UDP listener socket to a UDP connection between the endpoint device and the client device;
receiving Transport Layer Security (TLS) packets from the client device over the UDP tunnel;
performing TLS operations on the TLS packets independent of a user space application at the endpoint device; and
after performing the TLS operations, forwarding packet data directly into a kernel network stack of the endpoint device.

2. The method of claim 1, wherein the kernel space process performs additional operations comprising:
receiving plain-text packets that are destined for the UDP tunnel; and
forwarding the plain-text packets to the kernel network stack.

3. The method of claim 1, wherein the kernel space process performs additional operations comprising:
receiving one or more incoming TLS records from a target server;
decrypting the one or more incoming TLS records; and
providing the one or more decrypted TLS records to the user space application.

4. The method of claim 1, wherein the kernel space process performs additional operations comprising:
receiving one or more outgoing TLS records from the user space application;
encrypting the one or more outgoing TLS records; and
transmitting the one or more encrypted outgoing TLS records to a target server.

5. The method of claim 1, further comprising:
implementing an offload path process for the TLS packets;
wherein the offload path process is executed in a location selected from a group of the kernel space process, a network stack process, a Network Interface Card (NIC) of the endpoint device, a network processing unit of the endpoint device, or combinations thereof.

6. The method of claim 1, further comprising:
responsive to establishing the UDP tunnel, tracking a time since establishment of the UDP tunnel;
determining that a time threshold is reached based on tracking the time since establishment of the UDP tunnel; and
in response to the time threshold being reached, renegotiating the UDP tunnel.

7. The method of claim 1, further comprising:
maintaining a hash table that tracks active UDP connections per namespace;
determining that the UDP connection is ended; and
updating the hash table.

8. The method of claim 1, wherein the kernel space process performs additional operations comprising:
implementing a link-local authentication mechanism for additional user space authentication in addition to TLS authentication, wherein specific access control for link-local traffic is implemented before full traffic is allowed.

9. The method of claim 1, further comprising:
authenticating the client device associated with the UDP tunnel by carrying authentication traffic over the UDP tunnel while blocking non-authentication traffic.

10. The method of claim 9, further comprising:
carrying the authentication traffic using IPv6 link-local communications.

11. The method of claim 1, further comprising:
establishing an interface between the user space and a kernel space of the endpoint device with one or more of a block device driver, a character device driver, a Netlink socket, shared memory, and combinations thereof.

12. The method of claim 1, further comprising:
associating a respective identifier with the UDP connection; and
providing the respective identifier with the TLS packets that are forwarded from TLS processing directly into the kernel network stack.

13. An endpoint device comprising:
one or more processors; and
one or more computer-readable media, coupled to the one or more processors and having instructions stored thereon that, when executed by the one or more processors, cause the one or more processors to perform operations comprising:
receiving a request to establish a virtual private network (VPN) from a client device;
authenticating, in user space, the request from the client device; and
performing, by a kernel space process, operations comprising:
identifying activity at a User Datagram Protocol (UDP) listener socket that is associated with the VPN;
establishing a UDP tunnel between the endpoint device and the client device by mapping the UDP listener socket to a UDP connection between the endpoint device and the client device;
receiving Transport Layer Security (TLS) packets from the client device over the UDP tunnel;
performing TLS operations on the TLS packets independent of a user space application at the endpoint device; and
after performing the TLS operations, forwarding packet data directly into a kernel network stack of the endpoint device.

14. The endpoint device of claim 13, wherein the kernel space process performs additional operations comprising:
receiving plain-text packets that are destined for the UDP tunnel; and
forwarding the plain-text packets to the kernel network stack.

15. The endpoint device of claim 13, wherein the kernel space process performs additional operations comprising:
receiving one or more incoming TLS records from a target server;
decrypting the one or more incoming TLS records; and
providing the one or more decrypted TLS records to the user space application.

16. The endpoint device of claim 13, wherein the kernel space process performs additional operations comprising:
receiving one or more outgoing TLS records from the user space application;
encrypting the one or more outgoing TLS records; and
transmitting the one or more encrypted outgoing TLS records to a target server.

17. A computer-program product that includes one or more non-transitory computer-readable media with instructions stored thereon that, when executed by an endpoint device, causes the endpoint device to perform operations comprising:
receiving a request to establish a virtual private network (VPN) from a client device;
authenticating, in user space, the request from the client device; and
performing, by a kernel space process, operations comprising:
identifying activity at a User Datagram Protocol (UDP) listener socket that is associated with the VPN;
establishing a UDP tunnel between the endpoint device and the client device by mapping the UDP listener socket to a UDP connection between the endpoint device and the client device;
receiving Transport Layer Security (TLS) packets from the client device over the UDP tunnel;
performing TLS operations on the TLS packets independent of a user space application at the endpoint device; and
after performing the TLS operations, forwarding packet data directly into a kernel network stack of the endpoint device.

18. The computer-program product of claim 17, wherein the kernel space process performs additional operations comprising:
receiving plain-text packets that are destined for the UDP tunnel; and
forwarding the plain-text packets to the kernel network stack.

19. The computer-program product of claim 17, wherein the kernel space process performs additional operations comprising:
receiving one or more incoming TLS records from a target server;
decrypting the one or more incoming TLS records; and
providing the one or more decrypted TLS records to the user space application.

20. The computer-program product of claim 17, wherein the kernel space process performs additional operations comprising:
receiving one or more outgoing TLS records from the user space application;
encrypting the one or more outgoing TLS records; and
transmitting the one or more encrypted outgoing TLS records to a target server.
